(19) United States
(12) Patent Application Publication
(10) Pub. No.: US 2008/0162362 A1
(43) Pub. Date: Jul. 3, 2008

(54) INCREASING TRANSACTION AUTHENTICITY WITH PRODUCT LICENSE KEYS

(75) Inventor: Mohammed Moinuddin, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 11/617,496

(22) Filed: Dec. 28, 2006

(51) Int. Cl. G06Q 20/00; H04L 9/32

(52) U.S. Cl. 705/71

(57) ABSTRACT

Client computer systems can add authenticity to electronic payment requests through use of software license keys. In one implementation, for example, a payment request originating from a requestor (e.g., client computer system, point of sale terminal) sends one or more license key identifiers to a payment validating entity along with the payment details of the requested transaction. In addition to reviewing the payment transaction request and payment details for fraud, one or more payment validating entities can also review the one or more license key identifiers to determine if the request originates from as client computer system using valid software, or using potentially invalid or otherwise pirated software. In one implementation, the payment validating entities can deny a transaction originating from software from which validity cannot be determined. The payment validating entities can also, or alternatively, store information about the requestor for subsequent reporting purposes.

### CROSS-REFERENCE TO RELATED APPLICATIONS

N/A

### BACKGROUND

1. Background and Relevant Art

As computerized systems have increased in popularity, so also has the popularity of their use in transacting sales. For example, merchants have for some time now used electronic credit/debit card systems that can connect directly to a banking system with a modem. When connected, the banking system can then verify the purchaser's funds, deduct the funds (or available credit), and validate the transaction through the modem with a response message. More recently, however, many merchants are moving away from modem-based transactions, and moving toward Internet Protocol (“IP”) based transaction mechanisms (e.g., internet shopping).

In general, an internet-based validation of a sales transaction can occur a number of different ways. In one conventional mechanism, a cardholder presents a credit/debit card for goods and/or services to a merchant, such as at a store or online website. The merchant or cardholder enters (or swipes) the credit/debit card information into a computerized system, which then sends corresponding payment details in the form of one or more transaction requests to a payment gateway (or the payment processor) over a secure internet connection. The payment gateway (or the payment processor), in turn, can validate the one or more transaction requests.

For example, the payment gateway (or the payment processor) might try to determine if the entity identifying itself as the merchant can be validated, and/or if the requested transaction is within expected bounds. If the requested transaction appears valid, the payment gateway (or the payment processor) can then forward the transaction, to a payment processor (e.g., FDC, VITAL, PAYMENTTECH, etc.), which then gets forwarded to the card association (VISA or MASTERCARD, etc) and finally to the issuing bank over another secure internet connection.

The payment processor can also perform one or more checks by validating the authorization request with a corresponding card issuing bank. For example, the payment processor might examine the authorization request to determine if the request appears valid, and, if appropriate, send the authorization request to the card issuing bank. The card issuing bank can then authorize or decline (e.g., based on available funds/credit) the authorization request, and send a corresponding response back to the payment processor. The payment processor will then note the response from the card issuing bank, and forward the response to the payment gateway. The payment gateway can then generate and send an appropriately formatted response to the merchant. In general, one will appreciate that each of these communication sequences occurs over a secure internet connection.

Despite the case that any one or more of the above-identified entities may perform fraud or validation checks in the communication sequence, and despite the secure connections themselves, such internet-based payment authorization sequences can present a number of different exposures to fraud. For example, compared with direct connection systems (e.g., modem-based connections), internet-based authorization mechanisms can increase the number of independent entities that could be impersonated by a malicious party. Furthermore, since a user can submit payment information behind an IP address, rather than necessarily presenting a card with identification in-person, there is greater potential for end-users to be impersonated.

Detecting user impersonation, or impersonation of a merchant, continues to be a challenge for entities conducting sales over internet-based mechanisms. Beyond the difficulties previously mentioned, even where one of the entities, such as the payment gateway, card association, or issuing bank, detects user or merchant fraud, it can be difficult to trace the fraud back to the specific perpetrator. One reason for this is that fraudulent users are often also using pirated software, which can be difficult or impossible in some cases to trace to a particular end-point.

### BRIEF SUMMARY

Implementations of the present invention provide systems, methods, and computer program products configured to authenticate one or more payment transactions at least in part using software product license keys. In at least one implementation, for example, a user submits a payment request that includes various payment information (e.g., personal and/or payment account information), as well as one or more license key identifiers. The corresponding software provider can then separately validate the product license key before or while the other entities in the payment sequence validate the payment request. As a result, fraudulent requests originating from entities with invalid license keys can be denied outright if desired, while fraudulent requests originating from entities with valid product license keys can be traced more easily.

For example, one method in accordance with an implementation of the present invention from a client computer perspective can involve preparing one or more payment requests to be sent to one or more payment validating entities. Generally, the one or more payment requests will include account information. The method can also involve executing one or more instructions to identify one or more software license keys at the client computer system. In addition, the method can involve sending one or more corresponding license key identifiers to the one or more validating entities. Furthermore, the method can involve receiving one or more transaction responses to the one or more payment requests. Generally, the one or more transaction responses are based at least in part on the one or more license key identifiers.

By contrast, another method in accordance with an implementation of the present invention from a server perspective can involve receiving one or more payment requests from one or more client computer systems. The method can also involve identifying one or more license key identifiers corresponding to one or more product license keys at the one or more client computer systems. In addition, the method can involve validating the one or more payment requests. This can be done at least in part by comparing information corresponding to the one or more license key identifiers with software license key information in one or more license key databases. Furthermore, the method can involve sending one or more transaction responses to the one or more client computer systems. In general, the one or more transaction responses can be based at least in part on the comparison of the one or more license key identifiers via the one or more license key databases.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an overview schematic diagram in which one or more license key identifiers are used to help authenticate one or more payment transaction requests;

FIG. 2 illustrates flowcharts of methods from the perspective of a client and server for using one or more license key identifiers to authenticate payment one or more payment transaction requests.

### DETAILED DESCRIPTION

Implementations of the present invention extend to systems, methods, and computer program products configured to authenticate one or more payment transactions at least in part using software product license keys. In at least one implementation, for example, a user submits a payment request that includes various payment information (e.g., personal and/or payment account information), as well as one or more license key identifiers. The corresponding software provider can then separately validate the product license key before or while the other entities in the payment sequence validate the payment request. As a result, fraudulent requests originating from entities with invalid license keys can be denied outright if desired, while fraudulent requests originating from entities with valid product license keys can be traced more easily.

In general, one will appreciate that the mechanisms described herein are enabled at least partly since many software providers take great pains to restrict distribution of software. For example, many software providers today will block usage of a particular software program until a user provides a valid license key to the software through a user interface. If the license key matches one or more codes maintained by the software, the software may then be configured to unlock its operations. The key for users, therefore, is to obtain a valid software license key.

Traditionally, users can purchase and obtain the software license key along with the software of interest, while in other cases, the software provider may provide the license key through a separate transaction (e.g., mail, email, secure login, etc.) In any event, a software provider can often trace use of a particular license key to a user when the user purchases the software using a credit/debit card or check (or other traceable payment means). In other cases, the software provider may be able to trace use of a particular license key by requiring a given user to register the software with the software provider upon successful installation. The software provider might then deactivate properly registered software license keys for use by other users, or until the first user removes the software from the user's computer system. For example, the user might sell (or give) the software and corresponding software license key to another person, who might only be able to use the software and software license key after the initial user deactivates his account.

One will appreciate that software providers may use many different mechanisms for distributing and maintaining software license keys, and the strictness of these mechanisms can range greatly. For example, some software providers may provide software that can be installed multiple times using the same license key without triggering a warning. In other cases, the software providers may provide software that can be disabled instantly, out of caution, if the user changes one or more hardware components in the computer system. However done, software license keys can generally be used in most cases to identify a particular purchaser, or at least identify one or more users that are not too far removed from the original purchaser.

Accordingly, implementations of the present invention add one or more additional layers of authenticity, at least in part by correlating purchase requests with users of authentic software (who may be less likely to initiate a fraudulent transaction compared with users of pirated software). Furthermore, implementations of the present invention add layers of authenticity by making it easier to trace particular transactions back to specific software end-users. For example, and as will be understood more fully herein, a user posing as another to commit credit card fraud through an electronic purchase can be found more easily if the user is using valid (appropriately-licensed) software. Alternatively, a software provider can aid an account holder in tracing fraudulent purchases to a particular merchant where one user might have posed as another.

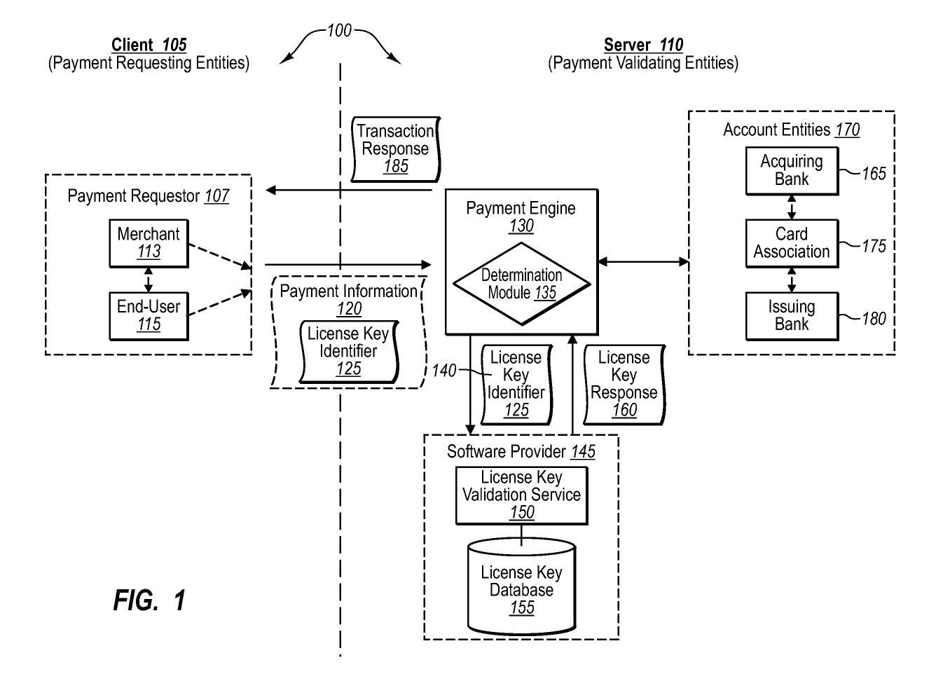

Accordingly, FIG. 1 illustrates an overview schematic diagram in accordance with an implementation of the present invention in which one or more clients submit one or more payment requests. In particular, FIG. 1 shows that a client 105, which represents one or more payment requesting entities, can include any number of payment requestors 107, such as merchant 113 or end-user 115. For example, end-user 115 presents account information to merchant 113 at a point-of-sale, or presents account information to merchant 113 via an ecommerce website.

In either case, FIG. 1 shows that payment requestor 107 will send one or more payment requests to a payment validating entity. In general, the one or more payment requests will include at least payment information 120, such as credit card number or bank account number information used to pay for the transaction, as well as any user names and password combinations (if needed), or the like. Payment information 120 will also generally include some basic information about the payment requestor 107, such as merchant ID, details of the transaction (e.g., purchase price, items to be purchased, etc.), as well as a location (e.g., internet protocol—IP—address, domain name, and/or physical address) of the payment requestor 107.

FIG. 1 also shows that payment requestor 107 can send a license key identifier 125 with payment information 120. In general, there are a number of ways in which license key identifier 125 can be generated. For example, when end-user 115 logs into a website to purchase an item, and selects a payment icon, one or more servers 100 of a payment validating entity that can then send one or more client scripts to the end-user's 115 computer system. Upon execution, the one or more client scripts identify one or more product license keys for a particular software provider, such as a license key for an operating system, a license key for one or more word processing programs, or for any other kinds of software that may be installed thereon.

In other cases, a personal computer system at a point of sale (e.g., at merchant 113) may not necessarily need to receive and process such scripts from a remote server 110. For example, a merchant 113 computer system at a point-of-sale terminal can be configured with resident software that automatically reviews the appropriate software license keys during each transaction. Thus, when an end-user presents credit or debit card information, and the cashier submits that information for payment, the resident software can review the software license keys.

However done, FIG. 1 shows that payment request 107 generates one or more license key identifiers 125 from the available software license keys. In general, generating the one or more license keys includes creating an encoded, encrypted, hashed, or otherwise altered form of the software license key. Of course, in the event a particular license key is sought but not available (e.g., using a pirated copy of a particular operating system), a license key identifier could still be generated that identifies no license key (or no valid license key) is present. In the event that the software may be pirated or otherwise invalid/expired, for example, the generated license key identifier could include information that a false version of a license key is present. According to in at least one implementation, therefore, the generated license key identifier is an encoded, encrypted, hashed, or otherwise altered form of the software license key, or of information indicating that a valid license key is not found.

FIG. 1 thus shows that payment requestor 107 sends the one or more license key identifiers 125 with payment information 120 to one or more servers 110, which represent one or more payment validating entities. In particular, FIG. 1 shows that server 110 can include any number of entities (and corresponding numbers of servers in a networked server system), such as payment gateway 130 (and corresponding servers), and software provider 145 (and corresponding servers). In addition, FIG. 1 shows that server 110 can also include any number of account entities 170, such as a acquiring bank 165 (and corresponding servers), card association 175 (and corresponding servers,) as well as issuing bank 180 (and corresponding servers).

In any event, FIG. 1 shows that, in at least one implementation, payment engine 130 receives payment information 120 including license key identifier 125, and processes this information through determination module 135. In one implementation, payment engine 130 is the service provider itself (rather than separate entity 145), which acts as an intermediary with account entities 170. In FIG. 1, however, payment engine 130 comprises a separate entity that determines how to handle received license key identifiers, as well as handle corresponding responses. For example, FIG. 1 shows that determination module 135 sends the license key identifier 125 in a separate request 140 to software provider 145.

In general, software provider 145 will be the provider for the software that is on a particular client system making the electronic payment request. For example, payment gateway 130 may have sent a script that identifies a product license key for one type of software provider, and thus sends a corresponding license key identifier received from the client computer system to that particular software provider. Alternatively, the client scripts sent by payment engine 130 might be configured to identify a license key provider for a number of applications handled by any number of software providers. Payment gateway 130 could then make determinations (e.g., via determination module 135) about the types of license key identifiers received, and to which software provider the license keys should be directed.

In most cases, however, and for purposes of simplicity, the license key identifier 125 will typically correspond to a ubiquitous operating system platform. One such operating system platform includes the MICROSOFT WINDOWS operating system. According to at least one implementation, therefore, software provider 145 and license key validation engine 150 represent entities associated with the MICROSOFT operating environment. Furthermore, the license key identifiers 125 represent encoded, encrypted, or hashed values of the client 105 MICROSOFT WINDOWS software license key. In such a case, payment engine 130 simply passes the license key identifier 125 to a MICROSOFT license validation engine.

In any case, FIG. 1 shows that payment engine 130 receives license key identifier 125, and passes this to software provider 145. Software provider 145 then processes this information through license key validation engine 150. For example, license key validation engine 150 decrypts or decodes any encryption/encoding of the license key identifier 125. License key validation engine 150 can then compare the decrypted/decoded license key information with license key database 155.

For example, license key database 155 can also include the storage of all valid and previously valid software license keys, as well as software license keys that have been known to have been pirated or stolen. License key database 155 can further include information regarding a portion of the expected locations (e.g., IP addresses, domain names, etc.) at which particular license keys can be expected to be found. This can help license key validation engine 150 also detect license keys originating from software that may have been installed on a particular domain outside of authorized bounds.

Upon making the appropriate comparisons between the information of message 140 and license key database 155, validation engine 150 can send a license key response 160 to payment gateway 130. In general, license key response 160 can include any number or type of information, such as that the software license key associated with license key identifier 125 is valid, that the software license key is invalid (or missing), or that there is some question about the authenticity of the software license key. For example, license key validation engine 150 may determine that the software license key associated with license key identifier 125 is valid, but associated with an unexpected domain or IP address.

Upon receipt of license key response 160, payment gateway 130 can then make a determination (e.g., via determination module 135) about whether to process the one or more payment requests. For example, if identifying from response 160 that the software at payment requestor 107 is invalid, pirated, or otherwise questionable, payment gateway 130 may raise an alert. In particular, payment gateway 130 can send a response (e.g., 185) to payment requestor 107 denying the one or more payment requests. Similarly, payment gateway 130 may simply just log evidence that the software at client 105 is or may be invalid, or that there has been some question about the authenticity of the software, and store this information for subsequent reporting purposes.

In cases where the originating software is valid, however, payment gateway 130 will generally communicate the one or more payment requests and account information to one or more account entities 170, as previously done. For example, payment gateway 130 can send payment information 120 along to acquiring bank 165 and card association 175, which can perform their own validation checks on the one or more payment requests. If appropriate, card association 175 can also pass payment information 120 to issuing bank 180. Alternatively, such as in the case of sending checking account information, payment gateway 130 may send corresponding payment information 120 directly to issuing bank 180, which then finalizes the one or more payment requests.

One will appreciate, therefore, that the account entities 170 can thus be the final arbiter as to whether the one or more payment requests are validated, despite any initial filtering for valid software license keys. For example, account entities 170 can continue to perform any account validation functions, or determinations regarding sufficiency of funds, etc., and then respond through the usual channels. In particular, FIG. 1 shows that account entities 170 can send any number of transaction response messages 185 back through payment gateway 130, which are further relayed and formatted for payment requester 107.

Accordingly, FIG. 1 illustrates a number of different components in at least one schematic arrangement for authenticating a payment transaction with a software license key. One will appreciate, however, that this particular schematic can be altered any number of ways for any number of communication efficiency or security concerns. For example, license key validation engine 150 may not necessarily be an entity operating independently from payment gateway 130 and/or account entities 170. In particular, license key validation engine 150 and license key database 155 could be located at payment gateway 130 and/or at any of server 110 of the account entities 170.

In such cases, one or more servers at payment gateway 130 can also perform license key validation functions in addition to any other fraud or transaction validation checks. Similarly, any of the one or more account entities 170 could be licensed to store and/or execute license key validation engine 150 and/or license key database 155 onsite. For example, account entities 170 can have license key validation engine 150 installed or otherwise located locally. The local license key validation engine 150, could nevertheless be configured to access license key database 155 offsite through software provider 145. In any case, account entities 170 could perform license key validation checks along with any number of other account validation checks, fund sufficiency checks, and/or transaction validation checks.

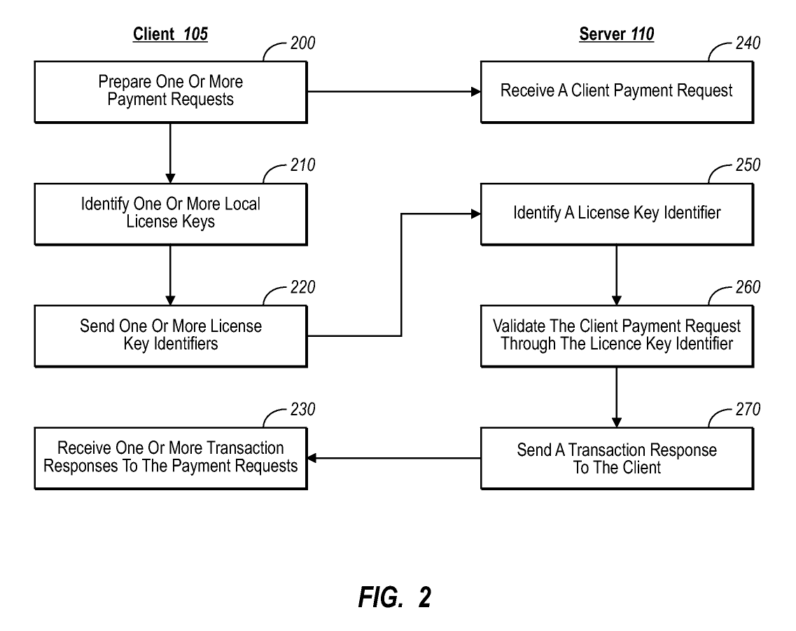

Implementations of the present invention can also be described in terms of flowcharts of one or more acts in methods from client and server perspectives for accomplishing a particular result. For example, FIG. 2 illustrates flowcharts from the perspective of client 105 (i.e., one or more client computer systems of payment requestor 107) and server 110 (i.e., one or more servers of payment validating entities) for completing one or more payment requests using one or more software license keys. The acts described below for FIG. 2 include reference to the components and diagrams of FIG. 1.

For example, FIG. 2 shows that a method from the perspective of client 105 can comprise an act 200 of preparing one or more payment requests. Act 200 includes preparing one or more payment requests to be sent to one or more payment validating entities, the one or more payment requests including account information. For example, FIG. 1 shows that payment requestor 107, such as merchant 113 or end-user 115, sends payment information 120 that can include any kind of credit card, debit card, checking account information and any corresponding information that would be required to process a particular payment request.

FIG. 2 also shows a method from the perspective of client 105 can comprise an act 210 of identifying one or more local license keys. Act 210 includes executing one or more instructions to identify one or more license keys at the client computer system. For example, FIG. 1 shows that payment requestor 107 sends license key identifier 125 to payment gateway 130. This can be generated in any number of ways, such as merchant 113 having a resident application that generates and sends product license key information along with the payment information 120. Alternatively, a client computer used by end-user 115 receives one or more client scripts in response to initiating one or more payment sequences of an online website. The client scripts then auto-generate the corresponding license key identifier 125 (e.g., through one or more background processes), which can then be sent with payment information 120.

Accordingly, FIG. 2 shows that the method from the perspective of client 105 includes an act 220 of sending one or more license key identifiers. Act 220 includes sending one or more corresponding license key identifiers to the one or more validating entities. For example, FIG. 1 shows that payment requestor 107 sends license key identifier 125 to payment gateway 130, which then processes this information through determination module 135 in conjunction with software provider 145.

In addition, FIG. 2 shows that the method from the perspective of client 105 can comprise an act 230 of receiving one or more transaction responses to the payment requests. Act 230 includes receiving one or more transaction responses to the one or more payment requests, the one or more transaction responses being based at least in part on the one or more license key identifiers. For example, payment requestor 107 receives transaction response 185 from payment gateway 130. Transaction response 185 has generated a response to authentication of the one or more license keys as well as authentication of the personal information used and processed by account entities 170.

By contrast, FIG. 2 shows that a method from the perspective of server 110 can comprise an act 240 of receiving a client 105 payment request. Act 240 includes receiving from one or more client computer systems one or more payment requests. For example, one or more servers 110, such as a server at payment gateway 130, receives payment information 120 which includes one or more requests to process a particular payment for a transaction.

FIG. 2 also shows that the method from the perspective of server 110 can comprise an act 250 of identifying a license key identifier. Act 250 includes identifying one or more license key identifiers corresponding to one or more license keys at the one or more client computer systems. For example, FIG. 1 shows that payment gateway 130 receives one or more license key identifiers 125 through determination module 135.

In addition, FIG. 2 shows that the method from the perspective of server 110 includes an act 260 of validating the client request through the license key identifier. Act 260 includes validating the one or more payment requests at least in part by comparing information corresponding to the identifying one or more license key responses to the identified one or more license key identifiers with one or more license key databases. For example, FIG. 1 shows that one or more servers of software provider 145 receive license key identifier 140 via license key validation engine 150. License key engine 150 then decrypts or decodes license key identifier 125 and compares the correspondingly decrypted or decoded information with software license key information in database 155 of license keys.

Furthermore, FIG. 2 shows the method from the perspective of server 110 can comprise an act 270 of sending a transaction response to the client. Act 270 includes sending one or more transaction responses to the one or more client computer systems, the one or more transaction responses being based at least in part on the comparison of the one or more license key identifiers via the one or more license key databases. For example, FIG. 1 shows that the collection of one or more servers 110 corresponding to one or more payment validating entities can generate license key response 160, which indicates whether license key identifier 125 is based on the presence of a valid software license key at client 105. The one or more servers 110 can then prepare transaction response 185 based on license key response 160, and then send transaction response 185 to payment requestor 107. In general, the transaction response 185 is based on one or more validations via account entities 170 as well as software provider 145.

Accordingly, FIGS. 1 and 2 provide a number of components, schematics, and mechanisms for adding authenticity and/or traceability to payment transaction requests. In particular, one will appreciate that this license key identifier can help in increasing the overall fraud rating of a particular payment transaction. For example, a payment validation engine can assume that payment requests originating from a valid software platforms have better chances of being legitimate. By contrast, the payment validation engine can assume that payment requests originating from a other types of software platforms, or pirated versions of a particular software platform (e.g., without a license key identifier, or with an errant identifier) are less trustworthy. This additional layer of guarantee in authorizing a payment request can generally be done real-time, and in a much quicker way than a payment request without the expected license key identifiers.

The embodiments of the present invention may comprise a special purpose or general-purpose computer including various computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer.

By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. At a client computer system in a computerized environment comprising one or more payment validating entities, a method of completing one or more payment requests using one or more software license keys on the client computer system, the method comprising the acts of:
preparing one or more payment requests to be sent to one or more payment validating entities, the one or more payment requests including account information;
executing one or more instructions to identify one or more software license keys at the client computer system;
sending one or more corresponding license key identifiers to the one or more validating entities; and
receiving one or more transaction responses to the one or more payment requests, the one or more transaction responses being based at least in part on a determined validity of the one or more license key identifiers.

2. The method as recited in claim 1, wherein the one or more license key identifiers are sent with the one or more payment requests.

3. The method as recited in claim 1, wherein the one or more instructions form part of a locally-installed application program at a point-of-sale terminal.

4. The method as recited in claim 1, further comprising the acts of:
the client computer system sending one or more electronic requests to a remote server to complete a payment transaction request; and
the client computer system receiving one or more client scripts from the remote server, wherein the one or more client scripts include the one or more instructions executed to identify the one or more software license keys.

5. The method as recited in claim 1, further comprising an act of the client computer system generating the one or more corresponding license key identifiers based on results of executing the one or more instructions to identify one or more software license keys.

6. The method as recited in claim 5, wherein the act of generating the one or more corresponding license key identifiers includes an act of encrypting an identified one of the one or more software license keys.

7. The method as recited in claim 5, wherein the act of generating the one or more corresponding license key identifiers includes an act of encoding an identified one of the one or more software license keys.

8. The method as recited in claim 5, wherein the results of executing the one or more instructions include information that the client computer system does not have a valid software license key.

9. The method as recited in claim 8, wherein the act of generating the one or more corresponding license key identifiers includes an act of generating a license key identifier that indicates that an expected software license key at the client computer system is missing.

10. The method as recited in claim 8, wherein the act of generating the one or more corresponding license key identifiers includes an act of generating a license key identifier that indicates that an expected software license key at the client computer system is fraudulent.

11. The method as recited in claim 8, further comprising receiving a transaction response that indicates that the one or more payment requests are denied due to failure to detect one or more valid software license keys.

12. At a server computer system of one or more payment validating entities in a computerized environment that includes one or more client computer systems, a method of finalizing one or more client payment requests based at least in part on identifying the presence of one or more license keys stored at the one or more client computer systems, the method comprising:
receiving from one or more client computer systems one or more payment requests;
identifying one or more license key identifiers corresponding to one or more product license keys at the one or more client computer systems;
validating the one or more payment requests at least in part by comparing information corresponding to the one or more license key identifiers with software license key information in one or more license key databases; and
sending one or more transaction responses to the one or more client computer systems, the one or more transaction responses being based at least in part on the comparison of the one or more license key identifiers via the one or more license key databases.

13. The method as recited in claim 12, further comprising an act of delivering one or more client instructions to the one or more client computer systems, the one or more client instructions configured to identify the one or more software license keys.

14. The method as recited in claim 13, further comprising an act of receiving the one or more license key identifiers separately from the one or more payment requests.

15. The method as recited in claim 12, further comprising an act of:
identifying a software provider corresponding to one or more software license keys from which the one or more license key identifiers were generated; and
sending the one or more license key identifiers to the identified software provider.

16. The method as recited in claim 15, further comprising an act of receiving the one or more license key responses from the identified software provider.

17. The method as recited in claim 12, wherein the one or more license key responses indicate that at least one of the one or more client computer systems does not report a valid software license key.

18. The method as recited in claim 17, wherein at least one of the one or more transaction responses to the at least one client computer system indicates that a corresponding payment request has been denied.

19. The method as recited in claim 12, wherein the one or more license key identifiers are one of encrypted or encoded, the method further comprising the acts of:
correspondingly decrypting or decoding the one or more license key identifiers; and
comparing the decrypted or decoded form of the one or more license key identifiers with information contained in the one or more license key databases.

20. At a server computer system of one or more payment validating entities in a computerized environment that includes one or more client computer systems, a computer-readable storage medium having computer-executable instructions stored thereon that, when executed, cause one or more processors at the server computer system to perform a method comprising:
receiving from one or more client computer systems one or more payment requests;
identifying one or more license key identifiers corresponding to one or more product license keys at the one or more client computer systems;
validating the one or more payment requests at least in part by comparing information corresponding to the one or more license key identifiers with software license key information in one or more license key databases; and
sending one or more transaction responses to the one or more client computer systems, the one or more transaction responses being based at least in part on the comparison of the one or more license key identifiers via the one or more license key databases.
